(19) United States
(12) Patent Application Publication
(10) Pub. No.: US 2007/0289096 A1
(43) Pub. Date: Dec. 20, 2007

(54) Two bar hinge assembly for casement windows

(76) Inventor: Mike (She Shun) Zhang, Mississauge (CA)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/436,936

(22) Filed: May 18, 2006

(51) Int. Cl. E05D 11/00

(52) U.S. Cl. 16/273

(57) ABSTRACT

A hinge assembly for retaining two linkage members in a rotational relationship for casement windows and the like. A hinge stud has its proximal end secured against rotation in an aperture of a first linkage and the hinge stud is provided with a projecting pivot and the pin portion of the stud extending through a second aperture in the second linkage for rotation between the two members. The pin is retained from dislodging by a circular snap ring received in an annular groove in the distal end of the pin. The snap ring is retained in fixed axial position and alignment relative to the second aperture in a tubular housing which is secured to the second linkage. This prevents the snap ring from ever engaging and breaching the finish provided on the second linkage.

### FIELD OF THE INVENTION

The present invention pertains to hinges for casement windows, and more particularly to a hinge assembly for casement windows which permits quick and reliable assembly.

### BACKGROUND OF THE INVENTION

A casement window is opened by pivoting the sash about one edge of the sash in contrast to double hung windows wherein the window is opened by sliding the sash along a track.

In a typical casement window, the bottom edge of the sash is supported by a long linkage member commonly referred to as a tie bar or sash arm that is slidably connected on one end to a track that is mounted to the window sill. A second linkage member, a shorter tie bar, is pivotally connected to the sash arm on one end and pivotally connected to the track at the other end. Current designs utilize a pivot pin that is riveted to the track and that passes through a hole in the tie bar. The tie bar is secured to the pin with a removable clip disposed on top of the tie bar so that the tie bar is sandwiched between the clip and the track. For example, see U.S. Reissue Pat. No. 35,635.

One of the problems incurred with this prior art arrangement is that the base material of the tie bars or linkage members is usually steel that is provided with a quality powder coated finish. The retainer clip compromises or breeches the finish in the area of the through hole for the hinge pin and every time the tie bars or linkages are snapped together at the hinge pin with the retainer clip, or disengaged, the retainer clip or C-ring digs into the soft powder coating. This causes premature failure of the part due to oxidation in the area of the compromised arm or linkage assembly.

Also, with hinge assemblies of prior art which are assembled with a snap fit, they are constructed such that if the window is in an opened position and downward force is applied to the arm or linkage, it can readily cause the linkage to tilt and disengage the hinge pin.

It is a principal object of the present invention to provide an improved snap fit hinge assembly which eliminates the foregoing disadvantages.

### SUMMARY OF THE INVENTION

The hinge assembly of the present invention is provided for retaining at least two linkages in rotational relationship to one another. The hinge assembly is comprised of a first linkage with a first aperture, a second linkage with a second aperture, and a hinge pin rotatably connecting the two. The hinge pin is provided by a hinge stud having a proximal end secured against rotation in the first aperture of the first linkage, and a distal end defining a projecting cylindrical pin. The pin extends through the second aperture in the second linkage for rotation therein and is retained from dislodging from the second aperture by a circular snap ring received in an annular groove in the distal end at a location beyond the exterior surface of the second linkage. The snap ring is retained in fixed axial position and alignment relative to the second aperture within a tubular snap ring housing which is secured to this second linkage. This arrangement prevents the circular snap ring from ever engaging and marring the surface of the linkages or linkage members and insures quick and easy snap connection and disconnection of the hinge assembly with secure retainment. Accordingly, the powder coating finish on the linkages are never compromised.

The snap ring is seamless and therefore this reduces the amount of friction required to engage the pin and enables seamless snap engagement in both a horizontal or vertical hinge position. Also, if unwanted downward forces are applied on one of the linkage members which would cause the linkage to tilt, the hinge assembly will not accidentally disengage.

No additional tools are required to engage or disengage the pin from the arm or linkage. One simply applies the appropriate amount of force to engage or disengage the assembly.

While the present invention is described in connection with a two bar hinge assembly, it must be remembered that the hinge assembly of the present invention is also applicable to dual arm, split arm and dyad operator arms which are connected to stud brackets, as well as to two bar hinge arms or linkages wherein the sash arm or linkage is attached to the hinge track.

The hinge assembly of the present invention provides window fabricators with a quick and efficient means to install hinge hardware at the factory or on the job site.

### BRIEF DESCRIPTION OF THE DRAWINGS

Other objects and advantages appear hereinafter in the following description and claims. The accompanying drawings show, for the purpose of exemplification, without limiting the present invention or the appended claims, certain practical embodiments of the present invention wherein:

FIG. 1 is a view in mid cross section of the hinge assembly of the present invention;

FIG. 2 is an isometric view of the circular retainer clip ring and its housing for the hinge assembly of the present invention with a front quarter section of the housing removed for viewing the interior parts;

FIG. 3 is an exploded isometric view of the hinge assembly of the present invention connecting two hardware linkage members; and

FIG. 4 is an isometric view showing the reverse side of the hinge assembly of FIG. 3.

### DESCRIPTION OF A PREFERRED EMBODIMENT

The hinge assembly 10 of the present invention retains at least two hardware linkage members 11 and 12, here respectively shown in the form of an operator stud bracket and a linkage or operator arm, in rotational relation to one another. The first linkage member 11 is provided with a first aperture 13 and the second hardware linkage member 12 is provided with a second aperture 14 at one end 15.

A stud 16 having a proximal end 17 and a distal end 18 is provided wherein the proximal end 17 provides a base portion 20 secured against rotation in first aperture 13 of first linkage member 11. Stud 16 is provided with a cylindrical projecting pivot pin portion 21 for protrusion through the second aperture 14 of second linkage member 12. Pin portion 21 is provided with an annular groove 22 in a position which is exposed on the distal end 18 beyond exterior face 23 of linkage member 12 when pin portion 21 has been fully inserted into aperture 14.

Circular snap retaining ring 24 is a metal continuous ring which is seamless for 360 and is dimensioned to be expandably force fit over the distal end 18 of projecting pivot pin portion 21 of the stud 16 and thereafter received in retaining groove 22 for retaining the stud 16 or pin portion 21 from withdrawal through second aperture 14. Snap ring housing 25 is provided with a tubular base portion 26 which is secured in the second cylindrical aperture 14 by having its proximal end 27 peaned over or crimped over as best indicated in FIG. 1 into counter bore or annular recess 28 provided on back surface 29 of linkage member 12. The tubular base portion 26 axially receives projecting pivot pin portion 21 therethrough in a guided pivotal relationship.

A tubular projecting portion 30 of snap ring housing 25 retains snap ring 24 therein in a fixed axial position for axial alignment with the distal end 18 of projecting pin portion 21 of stud 16 for axial engagement with the distal end 18 of the stud 16 whereby the linkage members 1I and 12 can be pivotally joined and disconnected with a snap fit.

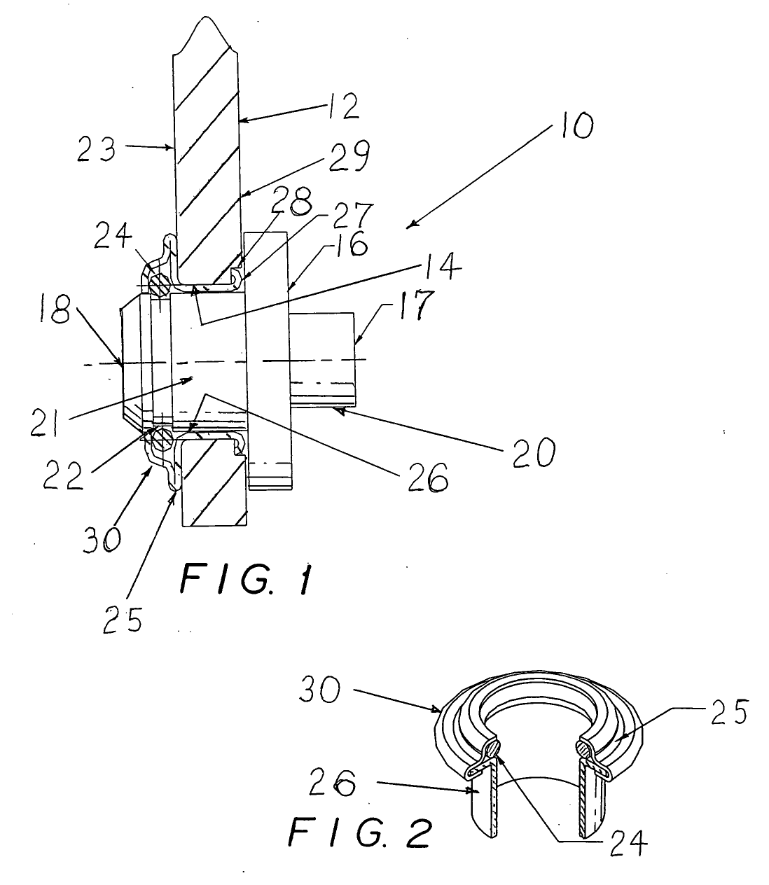

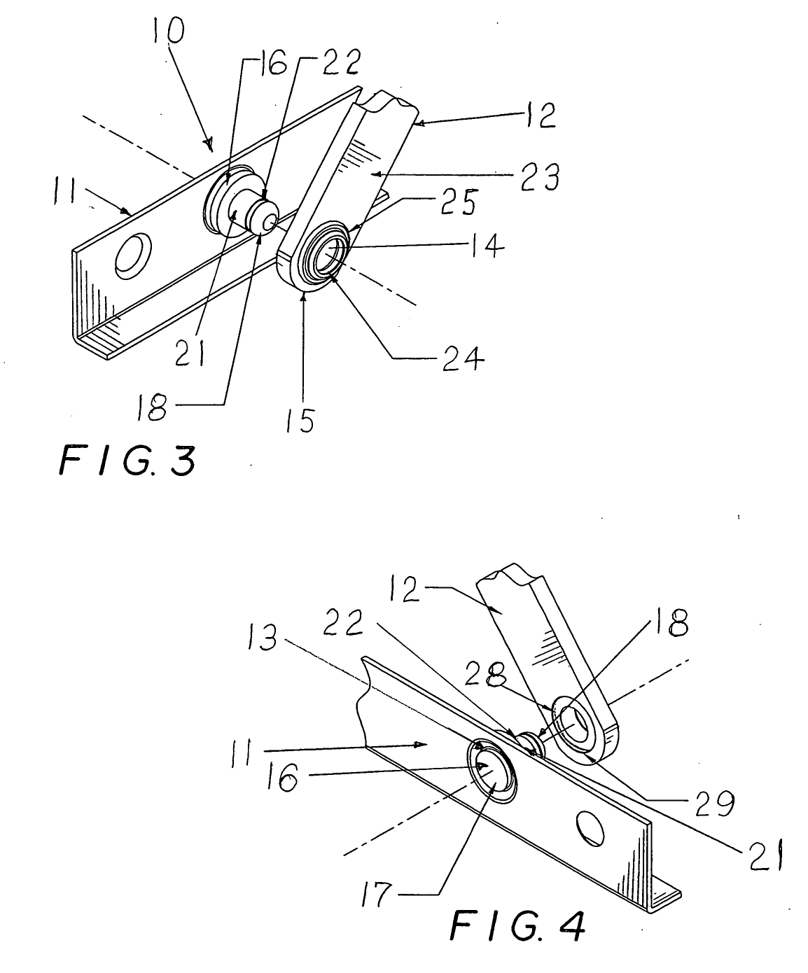

The snap ring housing 25 is illustrated in FIG. I as being assembled of one piece. However, it may also be assembled in two parts as illustrated in FIG. 2. The snap ring 24 is pre-installed inside the snap ring housing 25. The housing 25 is not shown in FIG. 4 for clarity.

I claim:

1. A hinge assembly for retaining at least two linkages in rotational relation to one another, the hinge assembly comprising:
a first linkage with a first aperture;
a second linkage with a second aperture;
a hinge stud having a proximal end secured against rotation in said first aperture of said first linkage, and a distal end defining a projecting cylindrical pin;
said pin extending through said second aperture in said second linkage for rotation therein and retained from dislodging therefrom by a circular snap ring received in an annular groove in said distal end at a location beyond an exterior surface of said second linkage; and
said snap ring retained in fixed axial position and alignment relative to said second aperture in a tubular housing secured to said second linkage.

2. The hinge assembly of claim 1, wherein said first and second linkages are part of a casement window two bar hinge assembly, and said linkages are steel with a powder coating finish.

3. The hinge assembly of claim 1, wherein said snap ring is seamless.

4. A hinge assembly for a casement window, the hinge assembly comprising;
a first hardware linkage member with a first aperture;
a second hardware linkage member with a second aperture at one end;
a stud having a proximal end a distal end, said proximal end providing a base portion secured against rotation in said first aperture of said first linkage member, and a cylindrical projecting pivot pin portion for protrusion through said second aperture of said second linkage member with an annular groove in an exposed position of said distal end;
a circular snap retaining ring dimensioned to be expandably force fit over said distal end of said projecting pivot pin portion of said stud and thereafter received in said groove for retaining said stud from withdrawal through said second aperture; and
a snap ring housing having a tubular base portion secured in said second cylindrical aperture of said second linkage member for axially receiving said stud projecting pivot pin portion therethrough in a guided pivotal relationship, and a tubular projecting portion retaining said snap ring therein in a fixed axial position for axial engagement with said distal end of said stud whereby said linkage members can be pivotally joined and disconnected with a snap fit.

5. The hinge assembly of claim 4, wherein said snap ring is seamless.

6. The hinge assembly of claim 4, wherein said linkage members are part of a casement window two bar hinge assembly, and said linkage members are steel with a powder coating finish.
